(19) United States
(12) Patent Application Publication
(10) Pub. No.: US 2015/0327065 A1
(43) Pub. Date: Nov. 12, 2015

(54) System for Handling Access by Wireless Devices in Wi-Fi Network

(71) Applicant: TELEFONAKTIEBOLAGET LM ERICSSON (PUBL), Stockholm (SE)

(72) Inventors: Gunnar Mildh, Sollentuna (SE); Göran Hall, Mölndal (SE); Anders Lundström, Sollentuna (SE); Stefan Rommer, Västra Frölunda (SE); Jari Vikberg, Järna (SE)

(21) Appl. No.: 14/646,529

(22) PCT Filed: Nov. 27, 2012
(86) PCT No.: PCT/SE2012/051305

§ 371 Date: May 21, 2015

(51) Int. Cl. H04W 12/06; H04W 48/02; H04L 29/06

(52) U.S. Cl. CPC H04W 12/06; H04L 63/0876; H04W 48/02

(57) ABSTRACT

A method for use in a network node (210, 220) in a Wi-Fi network (200) for handling an access attempt by a wireless device (121) is provided. The wireless device (121) is also configured to operate in a wireless telecommunications network (100). The wireless telecommunications network (100) comprises a policy control node (350) comprising information associated with the wireless device (121) that is registered via the wireless telecommunications network (100). The network node receives the information associated with the wireless device (121) from the policy control node (350) in response to transmitting an authentication request comprising an identifier associated with the wireless device (121) to an authentication node (510, 520) based on an access attempt to the Wi-Fi network (200) by the wireless device (121). Then, the network node determines whether or not the access attempt by the wireless device (121) to the Wi-Fi network (200) is allowed at least partly based on the received information. A network node is also described. Furthermore, an authentication node and a policy control node and methods therein are described.

### TECHNICAL FIELD

Embodiments herein relate to the handling of access attempts in a Wi-Fi network. In particular, embodiments herein relate to handling access attempts by wireless devices in Wi-Fi networks, which wireless devices are also configured to operate in a wireless telecommunications network.

### BACKGROUND

Mobile operators of wireless telecommunications networks are today mainly using Wi-Fi networks to offload data traffic from the wireless telecommunications networks. However, the opportunity to improve the end-user experience regarding performance in these networks is also becoming more important. Current Wi-Fi network deployments are almost totally separated from the wireless telecommunications networks, and may thus today be considered as two non-integrated networks.

The usage of Wi-Fi networks is mainly driven because of its free and wide unlicensed spectrum, as well as, the increased availability of Wi-Fi capabilities in wireless device, such as, e.g. smartphones and tablets. The end-users of the wireless devices are also becoming more and more comfortable with using Wi-Fi networks, e.g. at work, in offices and at home.

When considering integration possibilities of wireless telecommunications networks and Wi-Fi networks, this can be divided into two categories, i.e. mobile operator hosted/controlled Wi-Fi access points or third party hosted/controlled Wi-Fi access points. Here, the third party may be seen as anything else other than the mobile operator of the wireless communication network. The third party could e.g. be a Wi-Fi network operator, or the end-user. In both of these categories, there exist a variety of public hotspots, enterprise solutions and residential deployments.

Wi-Fi network integration towards the core network of wireless telecommunications networks is emerging as a potentially good way to improve end-user experience. Current solutions mainly comprise components, such as, a common authentication between the core network of wireless telecommunications network and Wi-Fi network, and integration of the Wi-Fi network user plane traffic towards the core network of wireless telecommunications network. The common authentication is based on an automatic subscriber identification module (SIM) based authentication for both access types. The Wi-Fi network user plane traffic integration provides the mobile operator of wireless telecommunications network with the opportunity to provide the same services for its end-users whether the end-users are connected via the wireless telecommunications network or via the Wi-Fi network. These services may e.g. comprise parental control and subscription based payments.

However, integration solutions for Wi-Fi networks into wireless telecommunications networks today does not offer any suitable support within a combined Wi-Fi and wireless telecommunications network.

### SUMMARY

It is an object of embodiments herein to improve the handling of an access attempt by a wireless device in a Wi-Fi network, which wireless device is also configured to operate in a wireless telecommunications network.

According to a first aspect of embodiments herein, the object is achieved by a method for use in a network node in a Wi-Fi network for handling an access attempt by a wireless device. The wireless device is also configured to operate in a wireless telecommunications network. The wireless telecommunications network comprises a policy control node comprising information associated with the wireless device that is registered via the wireless telecommunications network. The network node receives the information associated with the wireless device from the policy control node in response to transmitting an authentication request comprising an identifier associated with the wireless device to an authentication node based on an access attempt to the Wi-Fi network by the wireless device. Then, the network node determines whether or not the access attempt by the wireless device to the Wi-Fi network is allowed at least partly based on the received information.

According to a second aspect of embodiments herein, the object is achieved by a network node for handling an access attempt by a wireless device in a Wi-Fi network. The wireless device is configured to operate in a wireless telecommunications network. The wireless telecommunications network comprises a policy control node comprising information associated with the wireless device registered via the wireless telecommunications network. The network node comprises processing circuitry configured to receive information associated with the wireless device from the policy control node in response to transmitting an authentication request comprising an identifier associated with the wireless device to an authentication node based on an access attempt to the Wi-Fi network by the wireless device. The processing circuitry is also configured to determine whether or not the access attempt by the wireless device to the Wi-Fi network is allowed at least partly based on the received information.

According to a third aspect of embodiments herein, the object is achieved by a method for use in an authentication node for handling an authentication request from a network node in a Wi-Fi network. The authentication node is connected to the Wi-Fi network and a wireless telecommunications network. The authentication node receives the authentication request from the network node, which authentication request comprises an identifier associated with a wireless device. Also, the authentication node sends a request for information associated with the wireless device to a policy control node in the wireless telecommunications network. The information associated with the wireless device is registered in the policy control node via the wireless telecommunications network, and the request for information associated with the wireless device is based on the identifier associated with the wireless device. Then, the authentication node receives the requested information associated with the wireless device from the policy control node. Further, the the authentication node sends the received requested information associated with the wireless device to the network node in response to the authentication request.

According to a fourth aspect of embodiments herein, the object is achieved by an authentication node for handling an authentication request from a network node in a Wi-Fi network. The authentication node is connected to the Wi-Fi network and a wireless telecommunications network. The authentication node comprises processing circuitry configured to receive the authentication request from the network node which authentication request comprises an identifier associated with the wireless device. Also, the processing circuitry is configured to send a request for information associated with the wireless device to a policy control node in the wireless telecommunications network. The information associated with the wireless device is registered in the policy control node via the wireless telecommunications network, and the request for information associated with the wireless device is based on the identifier associated with the wireless device. Then, the processing circuitry is configured to receive the requested information associated with the wireless device from the policy control node. Further, the processing circuitry is configured to send the received requested information associated with the wireless device to the network node in response to the authentication request.

According to a fifth aspect of embodiments herein, the object is achieved by a method for use in a policy control node in a wireless telecommunications network for handling a request from an authentication node. The authentication node is connected to the wireless telecommunications network. The policy control node comprises information associated with wireless devices that is registered via the wireless telecommunications network. The policy control node receives a request for information associated with a wireless device from the authentication node. The request for information comprising an identifier associated with the wireless device. Then, the policy control node sends the requested information associated with the wireless device to the authentication node.

According to a sixth aspect of embodiments herein, the object is achieved by a policy control node in a wireless telecommunications network for handling a request from an authentication node. The authentication node is connected to the wireless telecommunications network. The policy control node comprises information associated with wireless devices that is registered via the wireless telecommunications network. The policy control node comprises processing circuitry configured to receive a request for information associated with a wireless device from the authentication node, which request for information comprises an identifier associated with the wireless device. Then, the processing circuitry is configured to send the requested information associated with the wireless device to the authentication node.

According to a seventh aspect of embodiments herein, the object is achieved by a system for handling an access attempt by a wireless device in a Wi-Fi network. The system comprises a network node comprised in the Wi-Fi network, and a policy control node comprised in a wireless telecommunications network, which policy control node comprises information associated with wireless devices that are registered via the wireless telecommunications network. The system also comprises an authentication node connected to the Wi-Fi network and the wireless telecommunications network. In the system, the network node is configured to transmit an authentication request comprising an identifier associated with the wireless device to an authentication node based on an access attempt to the Wi-Fi network by the wireless device. Also, in the system, the authentication node is configured to receive the authentication request from the network node and send a request for information associated with the wireless device to the policy control node, wherein the request for information associated with the wireless device is based on the identifier associated with the wireless device. Further, in the system, the policy control node is configured to receive the request for information associated with the wireless device from the authentication node, and to send the information associated with the wireless device to the authentication node. In the system, the authentication node is further configured to receive the information associated with the wireless device from the policy control node, and send the information associated with the wireless device to the network node in response to the authentication request. Also, in the system, the network node is further configured to receive the information associated with the wireless device from the policy control node in response to the transmitted authentication request, and determine whether or not the access attempt by the wireless device to the Wi-Fi network is allowed at least partly based on the received information.

When a wireless device is attempting to access the Wi-Fi network via a network node, the network node is provided with information. This information is comprised in a policy control node in the wireless telecommunications network in which the wireless device is registered. By providing a network node in a Wi-Fi network with this information, the network node is able to base its decision of whether or not to allow access to the Wi-Fi network based on information about the wireless device from both the wireless telecommunications network and the Wi-Fi network.

This means that policy control node information associated with the wireless device in the wireless telecommunications network, such as, e.g. information regarding Access Point Names (APNs) of active connections, what access technologies are used, active services, authorised bandwidth, etc., may be used by the network node in the Wi-Fi network to determine if it should allow the wireless device to access the Wi-Fi network.

Thus, the handling of access attempts by wireless devices in Wi-Fi networks, which wireless devices are also configured to operate in a wireless telecommunications network, is improved.

Other objects, advantages and novel features of the methods, network node, authentication node and policy control node will become apparent from the following detailed description.

### BRIEF DESCRIPTION OF THE DRAWINGS

Features and advantages of the embodiments will become readily apparent to those skilled in the art by the following detailed description of exemplary embodiments thereof with reference to the accompanying drawings, wherein:

FIG. 1 is a schematic block diagram illustrating embodiments in a wireless telecommunications network and a Wi-Fi network.

FIG. 2 is a schematic block diagram illustrating a Wi-Fi network and a wireless telecommunications network according to some embodiments.

FIG. 3 is a flowchart depicting embodiments of a method in a network node.

FIG. 4 is a block diagram depicting embodiments of a network node.

FIG. 5 is a flowchart depicting embodiments of a method in an authentication node.

FIG. 6 is a block diagram depicting embodiments of an authentication node.

FIG. 7 is a flowchart depicting embodiments of a method in a policy control node.

FIG. 8 is a block diagram depicting embodiments of a policy control node.

FIG. 9 is a schematic signalling diagram depicting handling an access attempt by a wireless device to a Wi-Fi network according to exemplary embodiments.

FIG. 10 is a schematic signalling diagram depicting handling an access attempt by a wireless device to a Wi-Fi network according to further exemplary embodiments.

### DETAILED DESCRIPTION

The figures are schematic and simplified for clarity, and they merely show details which are essential to the understanding of the embodiments presented herein, while other details have been left out. Throughout, the same reference numerals are used for identical or corresponding parts or steps.

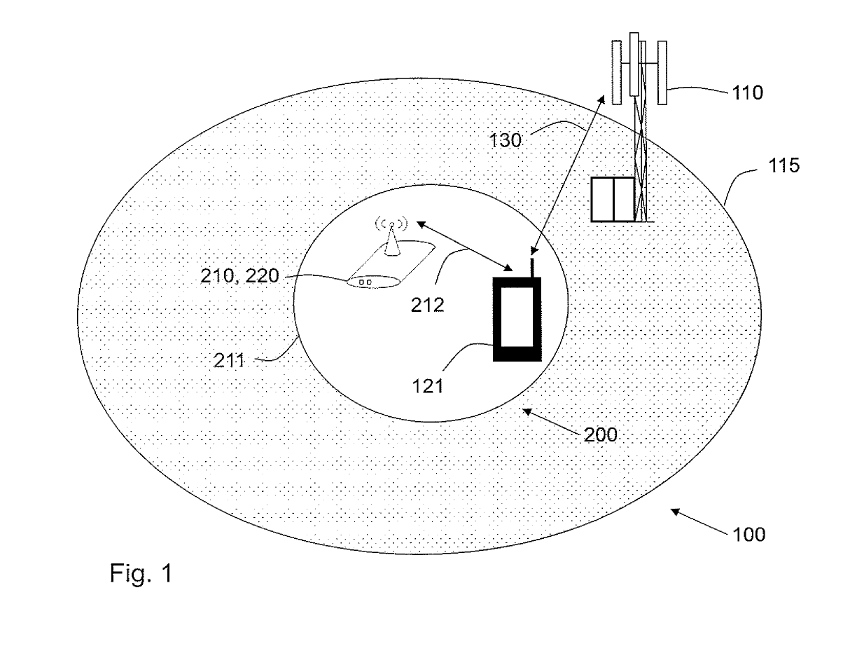

FIG. 1 depicts a wireless telecommunications network 100 in which embodiments herein may be implemented. In some embodiments, the wireless telecommunications network 100 may be a wireless telecommunication network such as an LTE, LTE-Advanced (LTE-A), WCDMA, UTRA TDD, GSM network, GPRS network, enhanced data rate for GSM evolution (EDGE) network, network comprising of any combination of Radio Access Technologies (RATs) such as e.g. Multi-Standard Radio (MSR) base stations, multi-RAT base stations etc., any 3GPP cellular network, WiMAX, or any cellular network or system.

The wireless telecommunications network 100 comprises a radio network node 110, which may be referred to as a base station. The radio network node 110 serves a cell 115. The radio network node 110 may in this example e.g. be an eNB, an eNodeB, or a Home Node B, a Home eNode B, a femto Base Station (BS), a pico BS or any other network unit capable to serve a wireless device or a machine type communication device which is located in the cell 115 in the wireless telecommunications network 100. The radio network node 110 may also be connected to a core network node (not shown) in the wireless telecommunications network 100.

A wireless device 121 is located within the cell 115. The wireless device 121 is configured to communicate within the wireless telecommunications network 100 via the radio network node 110 over a radio link 130 when the wireless device 121 is present in the cell 115 served by the radio network node 110. The wireless device 121, which also may be referred to as a user equipment (UE), may e.g. be a mobile terminal, a wireless terminal, a mobile phone, a computer such as e.g. a laptop, a Personal Digital Assistant (PDA) or a tablet computer, sometimes also referred to as a surf plate, with wireless capability, a device equipped with a wireless interface, such as a camera, a printer or a file storage device or any other radio network unit capable of communicating over a radio link in a telecommunications system. It should be noted that herein the terms “wireless device” and “user equipment” may be used interchangeably.

FIG. 1 further depicts a Wi-Fi network 200 in which embodiments herein may be implemented. The Wi-Fi network 200 may also be referred to herein as a Wi-Fi Access Network (AN).

The Wi-Fi network 200 comprises a network node 210, 220. The network node 210, 220 provides Wi-Fi coverage with a coverage area 212. The network node 210, 220 may e.g. be a Wi-Fi access node, which also may be referred to as a Wi-Fi Access Point (AP) or Wi-Fi Access Controller (AC), or any other network unit capable of serving the wireless device 121 when being located within the coverage area 212 in the Wi-Fi network 200 within the free and wide unlicensed spectrum for Wi-Fi.

The wireless device 121 is located within the coverage are 212. The wireless device 121 is configured to communicate within the Wi-Fi network 200 via the network node 210, 220 over a Wi-Fi link 211 when the wireless device 121 is present within the coverage area 212 served by the network node 210, 220. The wireless device 121 is provided with Wi-Fi capability for establishing and communicating via the Wi-Fi link 211.

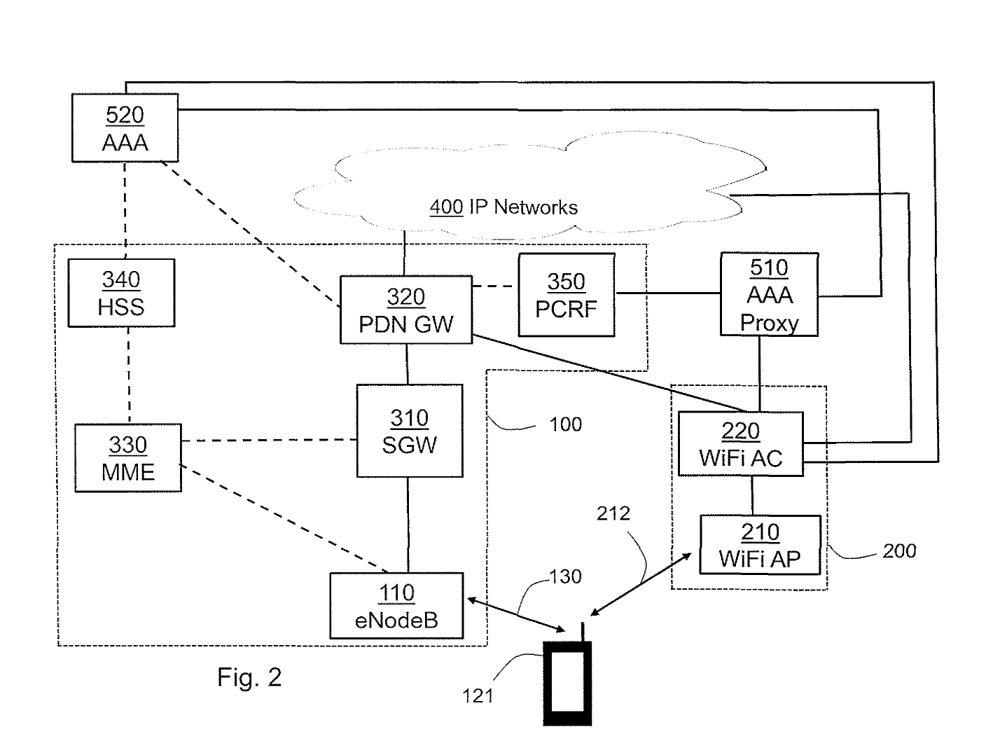

FIG. 2 depicts a more detailed view of the exemplary entities that may be comprised in the wireless telecommunications network 100 and the Wi-Fi network 200 in FIG. 1. Thus, FIG. 2 shows a wireless telecommunications network 100 and Wi-Fi network 200 according to some embodiments. The Wi-Fi network 200, or Wi-Fi Access Network (AN), is one example of a Wi-Fi deployment.

In FIG. 2, the Wi-Fi network 200 comprises at least one network node 210, 220, e.g. a Wi-Fi Access Point (AP) 210 and/or a Wi-Fi Access Controller (AC) 220.

A typical Wi-Fi deployment may comprise attaching one or more Wi-Fi APs 210 to a wired Local Area Network (LAN) (not shown), and then via the one or more Wi-Fi APs 210 provide wireless access for the wireless device 121 to the wired LAN. The one or more Wi-Fi APs 210 may be managed by the Wi-Fi AC 220, which may also be referred to as a Wireless LAN (WLAN) Controller. The Wi-Fi AC 220 conventionally may handle automatic adjustments to Radio Frequency (RF) power, channels, authentication, and security, etc.

The Wi-Fi AC 220 may be connected to a Packet Data Network (PDN) Gateway (GW) 320 in the wireless telecommunications network 100. The Wi-Fi AC 220 and the PDN GW 320 may also be connected to further IP-based networks 400, such as e.g. the Internet, etc. The link between the Wi-Fi AC 220 and the PDN GW 320 may e.g. be an S2a interface used for the Wi-Fi network user plane traffic.

The at least one network node 210, 220 is also connected to an authentication node 510, 520.

In some embodiments, the authentication node 510, 520 may be a wireless device authentication server 520 for wireless devices in the wireless telecommunications network 100. The wireless device authentication server 520 may also commonly be referred as an Authentication, Authorization and Accounting (AAA) server. The link between the at least one network node 210, 220 and the wireless device authentication server 520 may e.g. be a STa interface used for the common authentication between the core network of the wireless telecommunications network 100 and the Wi-Fi network 200.

In some embodiments, the authentication node 510, 520 may be an authentication proxy node 510 that is connected between the policy control node 350 and the wireless device authentication server 520. The authentication proxy node 510 may also herein be referred as an Authentication, Authorization and Accounting (AAA) proxy node. In some embodiments, the authentication proxy node 510 may be connected between the network node 210, 220 in the Wi-Fi network 200 and the wireless device authentication server 520.

It should be noted that the configuration of the Wi-Fi network 200 described above is only an illustrative example described to help understand the embodiments presented herein. It should therefore be understood that the Wi-Fi network 200 may be configured or arranged in several other ways and may comprise several further network nodes or entities. For example, the at least one network node 210, 220 may be connected to a Broadband Network Gateway (BNG) in the wired LAN. In another example, the at least one network node 210, 220 may be co-located with a Residential Gateway (RG). In a further example, the Wi-Fi network 200 may also comprise a Trusted WLAN Access Gateway (TWAG) configured to communicate with the at least one network node 210, 220.

It should also be understood that when the Wi-Fi network 200 is configured with such further network nodes or entities as described above, one or more of these further network nodes or entities may be configured to perform one or more of the actions or operations described as performed by at least one network node 210, 220.

For example, since the link between the Wi-Fi AC 220 and the PDN GW 320, e.g. an S2a interface, in the example shown in FIG. 2, may also be implemented between the PDN GW 320 and any one of the at least one network node 210, 220, BNG, RG, etc., the network node or entity connected to the PDN GW 320 may be configured to perform one or more of the actions or operations described as performed by the at least one network node 210, 220 as described herein or function as a simple intermediary node.

The wireless telecommunications network 100 shown in FIG. 2 is one example of simplified network architecture for an Evolved Universal Terrestrial Radio Access Network (E-UTRAN)/Evolved Packet Core (EPC) network.

The wireless telecommunications network 100 comprises the radio network node 110 as described above. The radio network node 110 may be connected to a Serving Gateway (SGW) 310, which in turn may be connected to the PDN GW 320. The radio network node 110 may also be configured to communicate with a Mobility Management Entity (MME) 330, which in turn may be configured to communicate with a Home Subscriber Server (HSS) 340. Both the PDN GW 320 and the HSS 340 may be configured to communicate with the wireless device authentication server 520.

A policy control node 350 is configured to communicate with the PDN GW 320 in the wireless telecommunications network 100. The policy control node 350 may also be referred to as the Policy and Charging Rules Function (PCRF) node.

The policy control node 350 makes up a key part of a concept called Policy and Charging Control (PCC) in the EPC network architecture, as well as, in the 3GPP packet core network architecture in general. The PCC concept is designed to enable flow-based charging which may comprise e.g. online credit control and policy control. The policy control node 350 may comprise support for service authorization and Quality-of-Service (QoS) management.

The policy control node 350 comprises policy control decision and flow-based charging control functionalities. The policy control node 350 is configured to receive service information comprising e.g. resource requirements and IP flow related parameters, from e.g. external application servers.

Furthermore, the policy control node 350 may subscribe to event triggers via a functionality referred to as the Event Reporting Function (ERF) that performs event trigger detection. The ERF may e.g. be located in the PDN GW 320. When an event matching the event trigger occurs, the ERF functionality may report the occurred event to the policy control node 350. A number of different event triggers are described in e.g. the 3GPP TS 23.203 standard, version 11.7.0, section 6.1.4, released on 2012-09-14. These event triggers comprise, e.g. Radio Access Technology (RAT) type change or Location change.

Hence, the policy control node 350 is continuously updated with information associated with the wireless device 121 registered via the wireless telecommunications network 100. Thus, the information associated with the wireless device 121 may concern, e.g. Access Point Names (APNs) of active connections of the wireless device 121, what access technologies are used by the wireless device 121, active services of the wireless device 121, authorised bandwidth of the wireless device 121, etc. Thus, in particular, the information may e.g. be the status of the wireless device 121 regarding last known RAT (e.g. 2G/3G/LTE), active Access Point Name (APNs), and/or applied charging and policy rules for the wireless device 121. However, further information may also be conceived in view of the different triggers described above.

It should be noted that while the embodiments herein are described in the context of an EPC network, as shown in FIG. 2, also other core networks for wireless/cellular technologies may support the policy control node 350, as well as, the interfaces for the authentication nodes 510, 520. In particular, the General Packet Radio Service (GPRS) core based on Serving GPRS Support Node (SGSN) and Gateway GPRS Support Node (GGSN) network entities may also support Policy Control using the policy control node 350, as well as, the interfaces for the authentication nodes 510, 520 and the interworking with the Wi-Fi network 200.

Also, since 3GPP2 has specified support for a policy control node, as well as, for AAA interfaces, the embodiments described herein of the network nodes 210, 220, the authentication nodes 510, 520, and the policy control node 350, may thus also be applied to those types of networks. The embodiments described herein of the network nodes 210, 220, the authentication nodes 510, 520, and the policy control node 350, may also be generalized to other networks supporting policy control and AAA functions.

According to the embodiments described herein, when the wireless device 121 is attempting to access the Wi-Fi network 200 via a network node 210, 220, the network node 210, 220 is provided with information. This information is comprised in the policy control node 350 in the wireless telecommunications network 100 in which the wireless device 121 is registered. By providing the network node 110 in the Wi-Fi network 200 with this information, the network node 110 is able to base its decision of whether or not to allow access for the wireless device 121 to the Wi-Fi network 200 based on information about the wireless device 121 from both the wireless telecommunications network 100 and the Wi-Fi network 200.

This means that policy control node information associated with the wireless device 121 in the wireless telecommunications network 100, such as, e.g. information regarding Access Point Names (APNs) of active connections, what access technologies are used, active services, authorised bandwidth, etc., may be used by the network node 110 in the Wi-Fi network 200 to determine if it should allow the wireless device 121 to access the Wi-Fi network 200.

Thus, the handling of access attempts by the wireless device 121 in the Wi-Fi networks 200, which wireless device 121 are also configured to operate in a wireless telecommunications network 100, is improved.

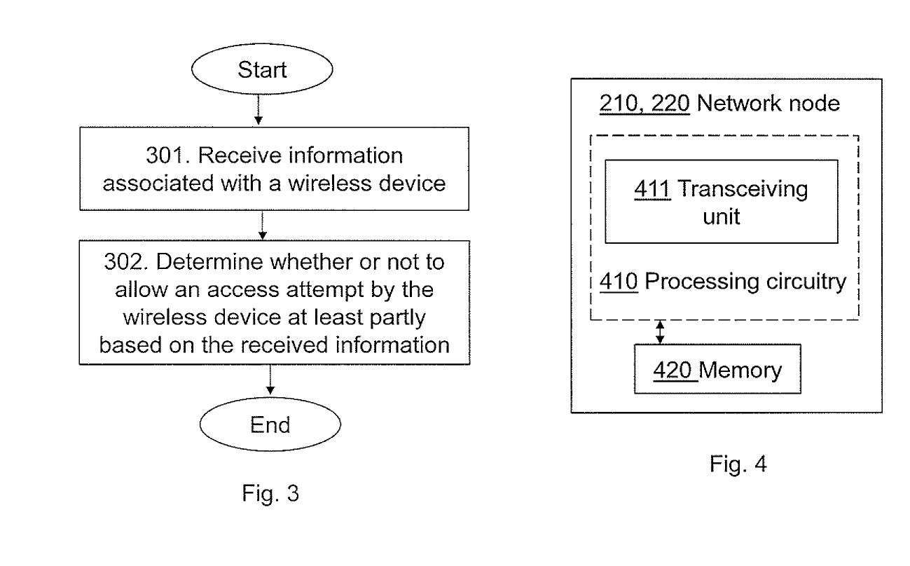

Embodiments of a method in a network node 210, 220 will now be described with reference to the flowchart depicted in FIG. 3. It should be noted that the network node 210, 220 may be implemented in the Wi-Fi AP 210, a Wi-Fi AC 220, a standalone node or entity between the Wi-Fi AP 210 or the Wi-Fi AC 220 and the authentication proxy node 510, or a standalone node or entity between the Wi-Fi AP 210 or the Wi-Fi AC 220 and the wireless device authentication server 520.

The flowchart in FIG. 3 describes a method for use in the network node 210 in the Wi-Fi network 200 for handling an access attempt by the wireless device 121. The wireless device 121 is also configured to operate in the wireless telecommunications network 100. The wireless telecommunications network 100 comprises the policy control node 350 comprising information associated with the wireless device 121 that is registered via the wireless telecommunications network 100.

FIG. 3 is an illustrating example of exemplary actions or operations which may be taken by the network node 210, 220. It should be appreciated that the flowchart diagram is provided merely as an example and that the network node 210, 220 may be configured to perform any of the exemplary actions or operations provided herein. It should be appreciated that the actions or operations illustrated below are merely examples, thus it may not be necessary for all the actions or operations to be performed. It should also be appreciated that the actions or operations may be performed in any combination or suitable order. The flowchart in FIG. 3 comprises the following actions, and may also be implemented for any of the above and below mentioned embodiments or in any combination with those.

Action 301.

In this action, the network node 210, 220 receives information associated with a wireless device. In particular, the network node 210, 220 receives information associated with the wireless device 121 from the policy control node 350. This is performed in response to transmitting an authentication request to the authentication node 510, 520 based on an access attempt to the Wi-Fi network 200 by the wireless device 121. The authentication request that is sent by the network node 210, 220 comprises an identifier associated with the wireless device 121.

A possible advantage by receiving information associated with the wireless device 121 from the policy control node 350 is that the network node 210, 220 is provided with information associated with the wireless device 121 comprised in the policy control node 350 in the wireless telecommunications network 100 in which the wireless device 121 is registered. This information may e.g. be the status of the wireless device 121 regarding last known RAT, e.g. 2G/3G/LTE, active APNs, and/or applied charging and policy rules for the wireless device 121 in the wireless telecommunications network 100. It should be noted that further information associated with the wireless device 121 available in the policy control node 350 may also be received by the network node 210, 220.

In some embodiments, the identifier associated with the wireless device 121 may be an International Mobile Subscriber Identity, IMSI. The IMSI may be defined as in 3GPP TS 23.003.

For example, as the wireless device 121 detects a preferred Wi-Fi AP 210 and attempt to access the Wi-Fi network 200 via the Wi-Fi AP 210, a standardised 802.11 layer 2 (L2) association between the wireless device 121 and the Wi-Fi AP 210 is created.

In some embodiments, this may trigger authentication signalling in the form of Extensible Authentication Protocol (EAP) signalling between the wireless device 121 and the Wi-Fi AP 210. The EAP signalling may e.g. be EAP-Subscriber Identity Module (EAP-SIM) signalling, EAP Authentication and Key Agreement (AKA/AKA′) signalling, etc. In this case, the wireless device 121 may use the full authentication network access identifier (NAI), comprising the IMSI of the wireless device 121, in an EAP response message. The IMSI of the wireless device 121 may then be used in signalling within the Wi-Fi network 200.

Hence, the network node 210, 220 may be informed about the IMSI of the wireless device 121. This may also cause the network node 210, 220 to transmit the authentication request to an authentication node 510, 520. The authentication request may for example be an EAP authentication request carried within a RADIUS Access Request comprising the full authentication NAI and the IMSI of the wireless device 121. It should be noted and understood that the IMSI is verified/authenticated first after the EAP-SIM or EAP-Authentication and Key Agreement (EAP-AKA/AKA′) signalling with the wireless device authentication server 520 is finalized.

Alternatively, in some embodiments, instead of using EAP signalling, the network node 210, 220 may use a RADIUS Authentication Request. This may e.g. be used for wireless devices without any SIM or Universal SIM, USIM. In this case, the network node 210, 220 will not have the IMSI of the wireless device 121 available. However, this may in some cases allow a subsequent use of the IP-address of the wireless device 121 by the authentication node 510, 520 when retrieving information from the policy control node 350. This IP-address may be provided by the wireless device 121 as part of the DHCP signalling in the Wi-Fi network 200. This may be performed e.g. in a handover case from the wireless communications network 100 to the Wi-Fi network 200.

Furthermore, in some embodiments, the identifier associated with the wireless device 121 may be a temporary identity. The temporary identity of the wireless device 121 may also be referred to as a pseudonym or a fast re-authentication identity. This temporary identity may then be mapped to an IMSI or a Mobile Station International Subscriber Directory Number, MSISDN, associated with the wireless device 121 by an wireless device authentication server 520. The MSISDN is e.g. in 3GPP TS 23.003.

This may e.g. be used when fast re-authentication is used between the wireless device 121 and the wireless device authentication server 520 in FIG. 2, since in this case, the network node 210, 220 will also not have the IMSI of the wireless device 121 available.

It should be noted that when the wireless device 121 attempts to access the Wi-Fi network 200, the wireless device 121 may be authenticated using EAP-SIM/AKA/AKA′ protocols, as mentioned above. The wireless device 121 may, in these cases, be identified by either the full authentication NAI or by the fast re-authentication NAI.

The full authentication NAI may comprise the IMSI of the wireless device 121. The fast re-authentication NAI may comprise the temporary identity of the wireless device 121. The temporary identity in the fast re-authentication NAI are similar to the temporary identity used in LTE access in the sense that it is the wireless device authentication server 520 that knows the relationship between the temporary identity, the fast re-authentication NAI and the IMSI of the wireless device 121. Therefore, it is the wireless device authentication server 520 that is aware of the relation between the temporary identity and the IMSI of the wireless device 121.

Action 302.

When the information associated with the wireless device 121 from the policy control node 350 has been received, the network node 210, 220 determines whether or not the access attempt by the wireless device 121 to the Wi-Fi network 200 is allowed at least partly based on the received information.

A possible advantage by determining whether or not the access attempt by the wireless device 121 to the Wi-Fi network 200 is allowed at least partly based on the received information, is that the information associated with the wireless device 121 in the policy control node 350 may comprise information about e.g. Access Point Names (APNs) of active connections of the wireless device 121, what access technologies are used by the wireless device 121, active services of the wireless device 121, authorised bandwidth of the wireless device 121, etc. This may subsequently be used to achieve a more balanced and informed decision in the network node 210, 220 whether or not to allow the access attempt by the wireless device 121 to the Wi-Fi network 200.

For example, by being able to take the policy control related input parameters into consideration when performing access type selection for the wireless device 121, the network node 210, 220 is enabled to take decisions whether the wireless device 121 should access the Wi-Fi network 200 or not depending on e.g. if the wireless device 121 is stationary, and/or has a good connection to the Wi-Fi AP 210, 220, etc.

In some embodiments, the network node 210, 220 may further perform the determination at least partly based on radio signal information between the network node 210, 220 and the wireless device 121. The radio signal information may here be the Wi-Fi radio information between the wireless device 121 and the Wi-Fi AP 210.

A possible advantage by combining the information received from the policy control node 350 and the radio signal information available in the Wi-Fi network 200, is that, in some cases, where the usage of solely radio signal information available in the Wi-Fi network 200 would result in accepting the access attempt from the wireless device 121, the decision may instead be a rejection of the access attempt from the wireless device 121 when this information is combined with the information from the policy control node 350. This also applies vice versa, i.e. while radio signal information solely may indicate a rejection of the access attempt from the wireless device 121, a decision based on both the radio signal information and the information from the policy control node 350 may result in accepting the access attempt from the wireless device 121.

In some embodiments, the received information from the policy control node 350 may comprise the active APN(s) for the wireless device 121. From an APN perspective, the most interesting part to the network node 210, 220 may be the different APNs for the wireless device 121 and the total number of these. The specific APN may be used by the network node 210, 220 to guide the decision to accept or reject the access attempt to the Wi-Fi network 200.

For example, if the wireless device 121 only has an IMS APN, the network node 210, 220 may prefer to keep the wireless device 121 to access via the wireless telecommunications network 100. On the other hand, if the wireless device 121 only has an “Internet” APN, the network node 210, 220 may prefer to accept wireless device 121 in Wi-Fi network 200.

Another example is the case when corporate APNs are used, and the related usage may e.g. be a policy to always put these on access via the wireless telecommunications network 100.

In some embodiments, the received information from the policy control node 350 may comprise the Access Point Name-Aggregate Maximum Bit Rate (APN-AMBR) for an APN for the wireless device 121. APN-AMBR is a maximum bit rate that the wireless device 121 is allowed to have for a specific APN.

Hence, e.g. if the user of the wireless device 121 is making a request to move a PDN Connection for a specific APN to the Wi-Fi network 200 from the wireless telecommunications network 100, the network node 210, 220 may determine based on the APN-AMBR of the specific APN and e.g. the load status of the Wi-Fi network 200 and the wireless telecommunications network 100, if the access of the wireless device 121 should move to the Wi-Fi network 200 or stay with access via the wireless telecommunications network 100.

In some embodiments, the received information from the policy control node 350 may comprise one or more of a Guaranteed Bit-Rate (GBR), a Maximum Bit-Rate (MBR), an Allocation Retention Policy (ARP) or a Policy and Charging Control (PCC) rule per Service Data Flow (SDF) for the wireless device 121.

For example, if the wireless device 121 has a GBR bearer, the network node 210, 220 may decide not perform a handover (HO) to the Wi-Fi network 200. According to another example, the wireless device 121 with a specific ARP may not be allowed to access via the Wi-Fi network 200 by the network node 210, 220.

In some embodiments, the received information from the policy control node 350 may comprise the last known used RAT (e.g. 2G/3G/LTE) of the wireless device 121. The network node 210, 220 may then e.g. decide to apply different policies for when the wireless device 121 is in 2G as compared to if wireless device 121 is in LTE.

Furthermore, since the policy control node 350 may know if the wireless device 121 doesn't have any active PDN connections over the wireless telecommunications network 100, the network node 210, 220 may decide to accept the wireless device 121 into the Wi-Fi network 200 unless it can be assumed that the wireless device 121 would be able to connect over the wireless telecommunications network 100 if access to the Wi-Fi network 200 is rejected.

In some embodiments, the received information from the policy control node 350 may comprise information regarding any ongoing or active services of the wireless device 121, when e.g. the ongoing or active services have been using an Rx interface comprised in the policy control node 350, or when Application Detection, e.g. based on Deep Packet inspection, has been performed in the PDN GW 320 or in a standalone Traffic Detection Function (TDF).

Further to, e.g. the Application Detection, PCC rules that have been created without prior Rx signalling may provide information about ongoing or active services to the policy control node 350 which subsequently may be received by the network node 210, 220. For example, for PCC rules activated due to wireless device initiated QoS requests, the policy control node 350 may be able to map the request to a service.

Hence, the network node 210, 220 may use this information to determine if a HO between the wireless telecommunications network 100 and the Wi-Fi network 200 is suitable. For example, by combining the service information with RAN-specific knowledge about capabilities of the wireless telecommunications network 100, such as, e.g. bandwidth and QoS capabilities of access via the wireless telecommunications network 100, the network node 210, 220 may e.g. decide that moving a streaming video to the Wi-Fi network 200 may be suitable, e.g. if the access via the wireless telecommunications network 100 is overloaded, or not suitable, e.g. if the QoS capability of Wi-Fi network 200 is not sufficient.

In some embodiments, the received information from the policy control node 350 may comprise charging control information, or charging related information, for the wireless device 121. This charging information may e.g. be comprised in PCC rules generated for a service.

This charging information may determine if an IP flow shall be charged or not charged. If an IP flow is to be charged, the PCC rule determines if the IP flow shall be online or offline charged, and whether time and/or volume based charging applies.

Here, the policy control node 350 may comprise information about spending limits from the charging system, and based on such information the network node 210, 220 may decide whether access via the wireless telecommunications network 100 or via the Wi-Fi network 200 is preferred. For example, a mobile operator may decide to restrict the Wi-Fi access when a certain spending limit has been reached, which restriction then may be executed by the network node 210, 220 accordingly.

To perform the method actions for handling an access attempt by the wireless device 121 in a network node 210, 220 in a Wi-Fi network 200, wherein the wireless device 121 is also configured to operate in a wireless telecommunications network 100, the network node 210, 220 may comprises the following arrangement depicted in FIG. 4.

FIG. 4 shows a schematic block diagram of embodiments of the network node 210. It should be noted that the network node 210, 220 depicted in FIG. 4 may represent embodiments when being implemented in e.g. a WiFi AP 210, a Wi-Fi AC 220, a standalone node or entity between the Wi-Fi AC 220 and the authentication proxy node 510, or a standalone node or entity between the Wi-Fi AC 220 and the wireless device authentication server 520.

As mentioned above, the network node 210, 220 is configured to handle an access attempt by the wireless device 121 in a Wi-Fi network 200. The wireless device 121 being further configured to also operate in a wireless telecommunications network 100. The wireless telecommunications network 100 comprises a policy control node 350 comprising information associated with the wireless device 121 registered via the wireless telecommunications network 100.

The network node 210, 220 comprises a processing circuitry 410. The processing circuitry 410 is configured to receive information associated with the wireless device 121 from the policy control node 350. This is performed in response to transmitting an authentication request comprising an identifier associated with the wireless device 121 to an authentication node 510, 520. The authentication request is based on an access attempt to the Wi-Fi network 200 by the wireless device 121. The processing circuitry 410 is also configured to determine whether or not the access attempt by the wireless device 121 to the Wi-Fi network 200 is allowed based on the received information.

In some embodiments, the processing circuitry 410 is further configured to determine whether or not the access attempt by the wireless device 121 to the Wi-Fi network 200 is allowed at least partly based on radio signal information between the network node 210, 220 and the wireless device 121.

In some embodiments, the identifier associated with the wireless device 121 may be an IMSI. Alternatively, the identifier associated with the wireless device 121 may be a temporary identity of the wireless device 121. In this case, the temporary identity of the wireless device 121 may be mapped to an IMSI/MSISDN associated with the wireless device 121 in a wireless device authentication server 520.

The processing circuitry 410 may further comprise a transceiving unit 411. The transceiving unit 411 may be configured to transmit and receive information in the processing circuitry 410. For example, transceiving unit 411 may be configured to transmit authentication requests comprising an identifier associated with the wireless device 121 to an authentication node 510, 520 when the wireless device 121 performs an access attempt to the Wi-Fi network 200. The transceiving unit 411 may also be configured to receive information associated with the wireless device 121 from the policy control node 350 in response to the transmission of the authentication request.

The embodiments herein for handling an access attempt by the wireless device 121 in the network node 210, 220 may be implemented through one or more processors, such as the processing circuitry 410 in the network node 210, 220 depicted in FIG. 4, together with computer program code for performing the functions and actions of the embodiments herein. The program code mentioned above may also be provided as a computer program product, for instance in the form of a data carrier carrying computer program code for performing the embodiments herein when being loaded into the processing circuitry 410 in the network node 210, 220. The computer program code may e.g. be provided as pure program code in the network node 210, 220 or on a server and downloaded to the network node 210, 220.

The network node 210, 220 may further comprise a memory 420 comprising one or more memory units. The memory 420 may be arranged to be used to store data, such as, e.g. the information associated with the wireless device 121 received from the policy control node 350, to perform the methods herein when being executed in the network node 210, 220.

Those skilled in the art will also appreciate that the processing circuitry 410 and the memory 420 described above may refer to a combination of analog and digital circuits, and/or one or more processors configured with software and/or firmware, e.g. stored in a memory, that when executed by the one or more processors such as the processing circuitry 410 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

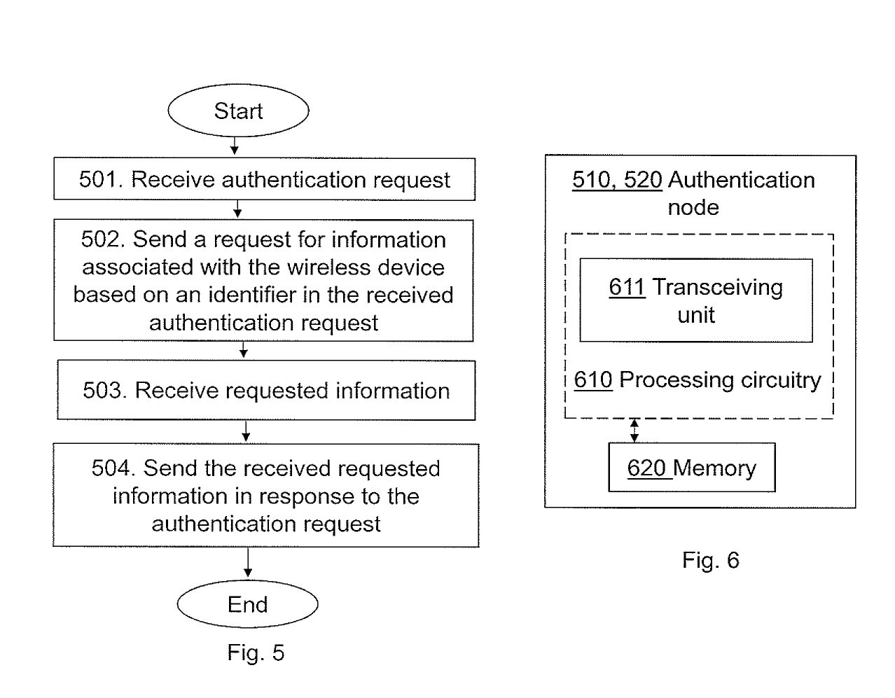

Embodiments of a method in an authentication node 510, 520 will now be described with reference to the flowchart depicted in FIG. 5.

The authentication node 510, 520 may be the authentication proxy node 510 or the wireless device authentication server 520. In some embodiments, when the authentication node 510, 520 is an authentication proxy node 510, the authentication proxy node 510 may be connected to the wireless device authentication server 520.

The flowchart in FIG. 5 describes a method for use in an authentication node 510, 520 for handling an authentication request from the network node 210, 220 in the Wi-Fi network 200. The authentication node 510, 520 is connected to the Wi-Fi network 200 and to the wireless telecommunications network 100.

FIG. 5 is an illustrating example of exemplary actions or operations which may be taken by an authentication node 510, 520. It should be appreciated that the flowchart diagram is provided merely as an example and that the authentication node 510, 520 may be configured to perform any of the exemplary actions or operations provided herein. It should be appreciated that the actions or operations illustrated below are merely examples, thus it may not be necessary for all the actions or operations to be performed. It should also be appreciated that the actions or operations may be performed in any combination or suitable order. The flowchart in FIG. 5 comprises the following actions, and may also be implemented for any of the above and below mentioned embodiments or in any combination with those.

Action 501.

In this action, the authentication node 510, 520 receives the authentication request from the network node 210, 220. The authentication request comprises an identifier associated with the wireless device 121.

In some embodiments, the identifier associated with the wireless device 121 may be an IMSI.

A possible advantage with the identifier associated with the wireless device 121 being an IMSI may be that, when the authentication node is an authentication proxy node 510, the signalling between the authentication proxy node 510 and the wireless device authentication server 520 may be reduced. A further advantage in this case is that no modification or adaptation of the wireless device authentication server 520 needs to be performed.

In some embodiments, the identifier associated with the wireless device 121 may be a temporary identity of the wireless device 121. In these cases, the temporary identity of the wireless device 121 may be mapped to an IMSI/MSISDN associated with the wireless device 121 in the wireless device authentication server 520. The temporary identity of the wireless device 121 may also be referred to as a pseudonym.

This means that the IMSI of the wireless device 121 will not be available in the uplink signalling to the authentication node 510, 520. Hence, in some embodiments, when the authentication node is an authentication proxy node 510, the authentication proxy node 510 may send the authentication request to the wireless device authentication server 520. In response, the authentication proxy node 510 may receive a response to the authentication request from the wireless device authentication server 520. The response to the authentication request from the wireless device authentication server 520 may comprise the IMSI/MSISDN associated with the wireless device 121. For example, the IMSI/MSISDN may be retrieved by the wireless device authentication server 520 from the HLR/HSS 340 shown in FIG. 2.

Thus, when the authentication node is an authentication proxy node 510, the authentication proxy node 510 is able to retrieve the IMSI/MSISDN associated with the wireless device 121 from the identifier comprised in the authentication request, i.e. the temporary identity.

Alternatively, in some embodiments, instead of using EAP-SIM signalling, the authentication node 510, 520 may receive a RADIUS Authentication Request. In this case, the authentication node 510, 520 may be made aware of an IP-address of the wireless device 121. This IP-address may be received from the wireless device 121 as part of the Dynamic Host Configuration Protocol, DHCP, signalling in the Wi-Fi network 200. This may be performed e.g. in a handover case from the wireless communications network 100 to the Wi-Fi network 200.

Action 502.

When the authentication request has been received, the authentication node 510, 520 sends a request for information associated with the wireless device 121 to a policy control node 350 in the wireless telecommunications network 100. The policy control node 350 comprises information associated with the wireless device 121 that is registered in via the wireless telecommunications network 100. The request for information associated with the wireless device 121 sent by the authentication node 510, 520 is based on the identifier associated with the wireless device 121.

Thus, in this way, the authentication node 510, 520 may gain access to information associated with the wireless device 121 that is registered in the policy control node 350 via the wireless telecommunications network 100.

In some embodiments, when the identifier associated with the wireless device 121 is a temporary identity of the wireless device 121 and the authentication node is an authentication proxy node 510, the authentication proxy node 510 may wait until the IMSI/MSISDN associated with the wireless device 121 has been received from the wireless device authentication server 520 before sending the request for information associated with the wireless device 121 to the policy control node 350. Then, the authentication proxy node 510 may send the request for information associated with the wireless device 121 to the policy control node 350 comprising the received IMSI/MSISDN from the wireless device authentication server 520.

Action 503.

In response to sending the request for information associated with the wireless device 121, the authentication node 510, 520 receives the requested information associated with the wireless device 121 from the policy control node 350.

Action 504.

When the requested information has been received, the authentication node 510, 520 sends the received requested information associated with the wireless device 121 from the policy control node 350 to the network node 210, 220 in response to the authentication request.

Thus, the authentication node 510, 520 may provide the network node 210, 220 with the information associated with the wireless device 121 that is registered in the policy control node 350 via the wireless telecommunications network 100.

In some embodiments, when the authentication node is an authentication proxy node 510, the authentication proxy node 510 must wait until the authentication request associated with the wireless device 121 has been received from the wireless device authentication server 520. Then, the authentication proxy node 510 may send the response to the authentication request and the received requested information associated with the wireless device 121 from the policy control node 350 to the network node 210, 220. Here, the authentication proxy node 510 may add the received requested information to signalling of the response to the actual authentication request.

To perform the method actions for handling an authentication request from a network node 210, 220 in a Wi-Fi network 200, the authentication node 510, 520 may comprise the following arrangement depicted in FIG. 6. FIG. 6 shows a schematic block diagram of embodiments of the authentication node 510, 520.

As mentioned above, the authentication node 510, 520 is configured to handle an authentication request from a network node 210, 220 in a Wi-Fi network 200. The authentication node 510, 520 is connected to the Wi-Fi network 200 and to the wireless telecommunications network 100.

The authentication node 510, 520 comprises a processing circuitry 610. The processing circuitry 610 is configured to receive the authentication request from the network node 210, 220. The authentication request comprises an identifier associated with the wireless device 121. The processing circuitry 610 is also configured to send a request for information associated with the wireless device 121 to a policy control node 350 in the wireless telecommunications network 100. The information associated with the wireless device 121 is registered in the policy control node 350 via the wireless telecommunications network 100. The request for information associated with the wireless device 121 is based on the identifier associated with the wireless device 121.

The processing circuitry 610 is further configured to receive the requested information associated with the wireless device 121 from the policy control node 350. Also, the processing circuitry 610 is configured to send a response to the authentication request and the received requested information associated with the wireless device 121 to the network node 210, 220. In some embodiments, the identifier associated with the wireless device 121 may be an IMSI.

In some embodiments, the authentication node may be an authentication proxy node 510 connected to a wireless device authentication server 520. Alternatively, the authentication node may be a wireless device authentication server 520.

In some embodiments, when the authentication node is an authentication proxy node 510, the processing circuitry 610 may further be configured to send the authentication request to the wireless device authentication server 520, and receive a response to the authentication request from the wireless device authentication server 520.

In some embodiments, when the identifier associated with the wireless device 121 is a temporary identity of the wireless device 121 and the authentication node is an authentication proxy node 510, the processing circuitry 610 may further be configured to receive an IMSI/MSISDN associated with the wireless device 121 from the wireless device authentication server 520. In this case, the processing circuitry 610 may also be configured to send the IMSI/MSISDN in the request for information associated with the wireless device 121 to the policy control node 350.

The processing circuitry 610 may further comprise a transceiving unit 611. The transceiving unit 611 may be configured to transmit and receive information from/to the processing circuitry 610 in the authentication node 510, 520. For example, transceiving unit 611 may be configured to receive the authentication request from the network node 210, 220. The transceiving unit 611 may also be configured to send a request for information associated with the wireless device 121 to a policy control node 350. Furthermore, the transceiving unit 611 may be configured to receive information associated with the wireless device 121 from the policy control node 350. Also, the transceiving unit 611 may be configured to send the received requested information associated with the wireless device 121 to the network node 210, 220 in response to the authentication request.

The embodiments herein for handling an authentication request from a network node 210, 220 in the authentication node 510, 520 may be implemented through one or more processors, such as the processing circuitry 610 depicted in FIG. 4, together with computer program code for performing the functions and actions of the embodiments herein. The program code mentioned above may also be provided as a computer program product, for instance in the form of a data carrier carrying computer program code for performing the embodiments herein when being loaded into the processing circuitry 610 in the authentication node 510, 520. The computer program code may e.g. be provided as pure program code in the authentication node 510, 520 or on a server and downloaded to the authentication node 510, 520.

The authentication node 510, 520 may further comprise a memory 620 comprising one or more memory units. The memory 620 may be arranged to be used to store data, such as, e.g. the information associated with the wireless device 121 received from the policy control node 350, to perform the methods herein when being executed in the authentication node 510, 520.

Those skilled in the art will also appreciate that the processing circuitry 610 and the memory 620 described above may refer to a combination of analog and digital circuits, and/or one or more processors configured with software and/or firmware, e.g. stored in a memory, that when executed by the one or more processors such as the processing circuitry 610 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

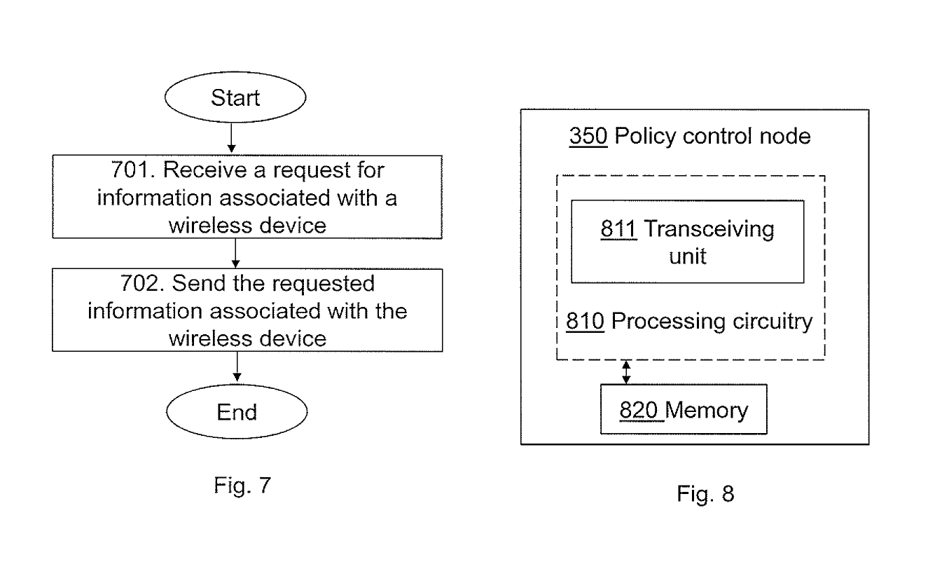

Embodiments of a method in a policy control node 350 will now be described with reference to the flowchart depicted in FIG. 7.

The flowchart in FIG. 7 describes a method for use in a policy control node 350 for handling a request from an authentication node 510, 520. The authentication node 510, 520 is connected to the wireless telecommunications network 100. The policy control node 350 comprises information associated with wireless devices that is registered via the wireless telecommunications network 100.

FIG. 7 is an illustrating example of exemplary actions or operations which may be taken by a policy control node 350. It should be appreciated that the flowchart diagram is provided merely as an example and that the policy control node 350 may be configured to perform any of the exemplary actions or operations provided herein. It should be appreciated that the actions or operations illustrated below are merely examples, thus it may not be necessary for all the actions or operations to be performed. It should also be appreciated that the actions or operations may be performed in any combination or suitable order. The flowchart in FIG. 7 comprises the following actions, and may also be implemented for any of the above and below mentioned embodiments or in any combination with those.

Action 701.

In this action, the policy control node 350 receives a request for information associated with the wireless device 121. This may be received from the authentication node 510, 520. The request for information comprises an identifier associated with the wireless device 121.

Action 702.

In response to the received request for information, the policy control node 350 may send the requested information associated with the wireless device 121 to the authentication node 510, 520.

In some embodiments, the identifier is an IMSI or a MSISDN. Alternatively, the identifier may be IP-address of the wireless device 121 registered in the wireless telecommunications system 100.

Hence, the policy control node 350 may provide the authentication node 510, 520 with information associated with the wireless device 121 that is registered in the policy control node 350 via the wireless telecommunications network 100. In some embodiments, the policy control node 350 is a Policy and Charging Rules Function, PCRF, node.

To perform the method actions for handling a request from an authentication node 510, 520, the policy control node 350 may comprise the following arrangement depicted in FIG. 8. FIG. 8 shows a schematic block diagram of embodiments of the policy control node 350.

As mentioned above, the policy control node 350 is configured to handle a request from an authentication node 510, 520. The authentication node 510, 520 is connected to the wireless telecommunications network 100. The policy control node 350 comprises information associated with wireless devices that is registered via the wireless telecommunications network 100.

The policy control node 350 comprises a processing circuitry 810. The processing circuitry 810 is configured to receive a request for information associated with the wireless device 121 from the authentication node 510, 520. The request for information comprises an identifier associated with the wireless device 121. The processing circuitry 810 is also configured to send the requested information associated with the wireless device 121 to the authentication node 510, 520. In some embodiments, the identifier is an IMSI or a MSISDN. In some embodiments, the policy control node 350 is a Policy and Charging Rules Function, PCRF, node.

It should also be noted that the policy control node 350 may be configured to support a number of different standards defining the task of a policy control node 350 in a wireless telecommunications system 100; such standards may e.g. comprise 3GPP TS 23.203, 3GPP TS 29.213, 3GPP TS 29.212, 3GPP TS 29.214, etc.

The processing circuitry 810 may further comprise a transceiving unit 811. The transceiving unit 811 may be configured to transmit and receive information from/to the processing circuitry 810 in the policy control node 350. For example, transceiving unit 811 may be configured to receive a request for information associated with the wireless device 121 from the authentication node 510, 520. The transceiving unit 811 may also be configured to send the requested information associated with the wireless device 121 to the authentication node 510, 520.

The embodiments herein for handling a request for information associated with the wireless device 121 from the authentication node 510, 520 in the policy control node 350 may be implemented through one or more processors, such as the processing circuitry 810 depicted in FIG. 8, together with computer program code for performing the functions and actions of the embodiments herein. The program code mentioned above may also be provided as a computer program product, for instance in the form of a data carrier carrying computer program code for performing the embodiments herein when being loaded into the processing circuitry 810 in the policy control node 350. The computer program code may e.g. be provided as pure program code in policy control node 350 or on a server and downloaded to the policy control node 350.

The policy control node 350 may further comprise a memory 820 comprising one or more memory units. The memory 820 may be arranged to be used to store data, such as, e.g. the information associated with the wireless device 121 is registered via the wireless telecommunications network 100, to perform the methods herein when being executed in the policy control node 350.

Those skilled in the art will also appreciate that the processing circuitry 810 and the memory 820 described above may refer to a combination of analog and digital circuits, and/or one or more processors configured with software and/or firmware, e.g. stored in a memory, that when executed by the one or more processors such as the processing circuitry 810 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

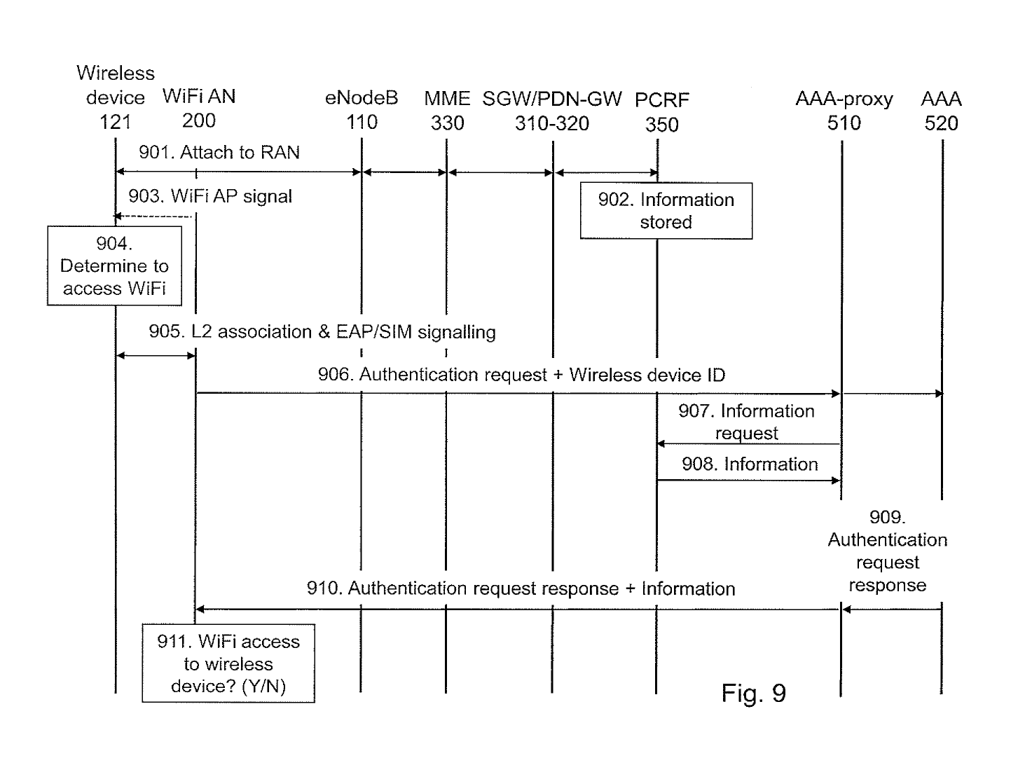

FIG. 9 is a schematic signalling diagram depicting handling an access attempt by the wireless device 121 to the Wi-Fi network 200 according to some embodiments.

Action 901.

In this action, the wireless device 121 is initially attached to radio access network (RAN) of the wireless telecommunications network 100, e.g. via the eNodeB 110. This will also cause the wireless device 121 to be registered in the core network of the wireless telecommunications network 100, e.g. MME 330, SGW/PDN-GW 310/320, PCRF 350, etc.

Action 902.

As a consequence of the attachment of the wireless device 121, the PCRF 350 will register or be updated with information regarding the wireless device 121 in the wireless communications network 100.

Action 903.

In this action, the wireless device 121 detects the Wi-Fi access network (AN) 200, e.g. by receiving a signal from the network node 210, 220 in the Wi-Fi access network (AN) 200.

Action 904.

Following the detection of the network node 210, 220 in the Wi-Fi AN 200, the wireless device 121 may determine to attempt access to the Wi-Fi AN 200.

Action 905.

In performing the access attempt towards the Wi-Fi AN 200, the wireless device 121 may first create an 802.11 L2 association with the network node 210, 220. This may cause EAP-SIM signalling between the wireless device 121 and the Wi-Fi AP 210. In this exemplary embodiment, the wireless device 121 may, in the EAP-SIM signalling, use the full authentication NAI that comprises the IMSI of the wireless device 121.

Action 906.

In response to the access attempt and signalling between the wireless device 121 and the network node 210, 220, the network node 210, 220 may send an authentication request comprising the IMSI of the wireless device 121 to a wireless device authentication server 520. For example, the Wi-Fi AP 210 or Wi-Fi AC 220 may perform an EAP-SIM authorisation towards the wireless device authentication server 520 by sending a RADIUS Access Request comprising the IMSI of the wireless device 121.

According to some embodiments, the authentication request comprising the IMSI of the wireless device 121 may be received by an authentication proxy node 510. The authentication proxy node 510 may then send the authentication request comprising the IMSI of the wireless device 121 to the wireless device authentication server 520.

Alternatively, in some embodiments, the authentication request comprising the IMSI of the wireless device 121 may be received by the wireless device authentication server 520 directly, i.e. without going via an authentication proxy node 510 (not shown).

Action 907.

According to some embodiments, since the authentication proxy node 510 may be informed about the IMSI of the wireless device 121 via the authentication request, the authentication proxy node 510 may send a request for information associated with the wireless device 121 to the PCRF 350. This means that the authentication proxy node 510 may contact the PCRF 350 in the wireless communications network 100, and thus retrieve information associated with the wireless device 121 from the wireless communications network 100.

Alternatively, this may be performed directly by the wireless device authentication server 520 when the authentication request comprising the IMSI of the wireless device 121 is received directly by the wireless device authentication server 520 (not shown).

Action 908.

According to some embodiments, in response to the request for information associated with the wireless device 121 from the authentication proxy node 510, the PCRF 350 may send the information associated with the wireless device 121 it has stored back to the authentication proxy node 510.

Alternatively, the information associated with the wireless device 121 may be sent to the wireless device authentication server 520 (not shown).

Action 909.

According to some embodiments, in response to the authentication request comprising the IMSI of the wireless device 121 from the authentication proxy node 510, the wireless device authentication server 520 may send a response to the authentication request back to the authentication proxy node 510. For example, the wireless device authentication server 520 may respond to the RADIUS Access Request with a RADIUS Access Challenge.

Alternatively, the wireless device authentication server 520 may send a response to the authentication request and the information associated with the wireless device 121 to the network node 210, 220 in the Wi-Fi AN 200.

Action 910.

According to some embodiments, in response to receiving the response to the authentication request from the wireless device authentication server 520 and the information associated with the wireless device 121 from the wireless communications network 100 from the PCRF 350, the authentication proxy node 510 may send the response and the information to the network node 210, 220 in the Wi-Fi AN 200. In some embodiments, the authentication proxy node 510 may add the information associated with the wireless device 121 to the response from the wireless device authentication server 520, e.g. comprised in the RADIUS Access Challenge signalling.

Action 911.

Thus, upon receiving the response and the information associated with the wireless device 121, the network node 210, 220 in the Wi-Fi AN 200 are informed about the information associated with the wireless device 121 registered in the PCRF 350 and may use this information in order to determine whether to allow or reject the access attempt from the wireless device 121.

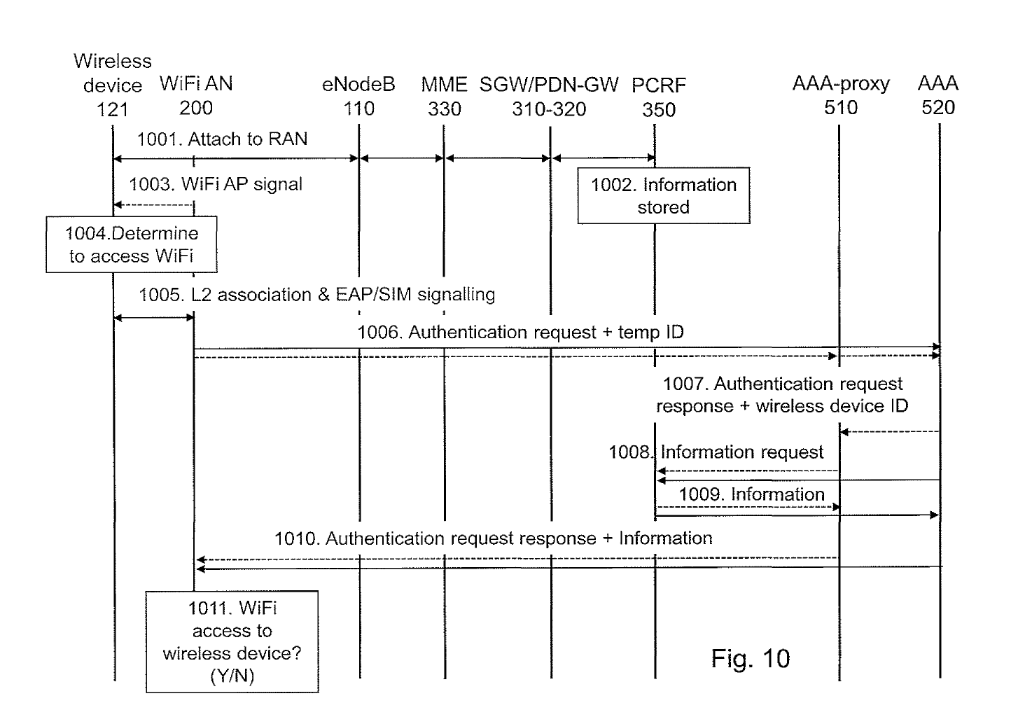

FIG. 10 is a schematic signalling diagram depicting handling an access attempt by the wireless device 121 to a Wi-Fi network 200 according to some further embodiments.

Actions 1001-1004 corresponds to the Actions 901-904 already described above with reference to FIG. 9.

Action 1005.

In performing the access attempt towards the Wi-Fi AN 200, the wireless device 121 may first create a 802.11 layer 2 association with the network node 210, 220. This may cause EAP-SIM signalling between the wireless device 121 and the network node 210, 220.

However, in this exemplary embodiment and e.g. when fast re-authentication is used, the wireless device 121 may, in the EAP-SIM signalling, use a temporary identity of the wireless device 121, e.g. a pseudonym or a fast re-authentication identity.

Action 1006.

In response to the access attempt and signalling between the wireless device 121 and the network node 210, 220, the network node 210, 220 may send an authentication request comprising the temporary identity of the wireless device 121 to a wireless device authentication server 520. For example, the network node 210, 220 may trigger an EAP-SIM authentication towards the wireless device authentication server 520 by sending a RADIUS Access Request comprising the temporary identity.

According to some embodiments, the authentication request comprising the temporary identity of the wireless device 121 may be received by the wireless device authentication server 520. This is shown by the fully drawn arrow in FIG. 10. The wireless device authentication server 520 may comprise a mapping between the temporary identity of the wireless device 121 and the International Mobile Subscriber Identity, IMSI, of the wireless device 121.

Alternatively, in some embodiments, the authentication request comprising the temporary identity of the wireless device 121 may be received by an authentication proxy node 510. This is shown by dashed arrows in FIG. 10. In this case, the authentication proxy node 510 may send the authentication request comprising the temporary identity of the wireless device 121 to the wireless device authentication server 520.

Action 1007.

When the authentication request comprising the temporary identity of the wireless device 121 is received in the authentication proxy node 510, the authentication proxy node 510 may wait until a response to the authentication request from the wireless device authentication server 520 is received before sending a request for information associated with the wireless device 121 to the PCRF 350. This is because the wireless device authentication server 520 may add the IMSI of the wireless device 121 that is mapped to the temporary identity of the wireless device 121 in the response to the authentication request. Thus, upon receiving the response to the authentication request, the authentication proxy node 510 is informed of the IMSI of the wireless device 121. This is shown by a dashed arrow in FIG. 10.

Optionally, the Mobile Station International Subscriber Directory Number, MSISDN, may here be used instead of the IMSI.

Action 1008.

When the authentication request comprising the temporary identity of the wireless device 121 is received in the wireless device authentication server 520 directly, i.e. without going via the authentication proxy node 510, the wireless device authentication server 520 may send a request for information associated with the wireless device 121 to the PCRF 350. This may be performed based on the IMSI of the wireless device 121 that is mapped to the temporary identity of the wireless device 121.

This means that the wireless device authentication server 520 may contact the PCRF 350 in the wireless communications network 100, and thus retrieve information associated with the wireless device 121 from the wireless communications network 100. This is shown by the fully drawn arrow in FIG. 10.

Alternatively, when the authentication request comprising the temporary identity of the wireless device 121 is received in the authentication proxy node 510, the authentication proxy node 510 may send a request for information associated with the wireless device 121 to the PCRF 350. This may then be performed based on the IMSI of the wireless device 121 received in the response to the authentication request from wireless device authentication server 520. This is shown by a dashed arrow in FIG. 10.

Action 1009.

In response to the request for information associated with the wireless device 121 from the authentication proxy node 510 or the wireless device authentication server 520, the PCRF 350 sends the information associated with the wireless device 121 it has stored back to the authentication proxy node 510 or the wireless device authentication server 520.

Hence, the authentication proxy node 510 or the wireless device authentication server 520 may receive the information associated with the wireless device 121 stored in the PCRF 350. This is shown by a dashed and a fully drawn arrow in FIG. 10, respectively.

Action 1010.

According to some embodiments, in response to receiving the information associated with the wireless device 121 in the wireless communications network 100 from the PCRF 350, the wireless device authentication server 520 may send the response to the authentication request and the received information from the PCRF 350 to the network node 210, 220 in the Wi-Fi AN 200. This is shown by a fully drawn arrow in FIG. 10.

Alternatively, in response to receiving the response to the authentication request from the wireless device authentication server 520 and the information associated with the wireless device 121 from the wireless communications network 100 from the PCRF 350, the authentication proxy node 510 may send the response and the information to the network node 210, 220 in the Wi-Fi AN 200. This is shown by a dashed arrow in FIG. 10.

Action 1011 corresponds to the Action 911 already described above with reference to FIG. 9.

A system comprising the network node 210, 220, the authentication node 510, 520 and the policy control node 350 as described above is also provided.

The system may be described as a system for handling an access attempt by a wireless device in a Wi-Fi network. This system comprises the network node 210, 220 as described above with reference to FIGS. 3-4. Also, this system comprises the authentication node 510, 520 as described above with reference to FIGS. 5-6. Further, this system comprises the policy control node 350 as described above with reference to FIGS. 7-8. Some embodiments of the network node 210, 220, the authentication node 510, 520, and the policy control node 350 in the system may also be described above with reference to FIGS. 9-10.

The terminology used in the detailed description of the particular exemplary embodiments illustrated in the accompanying drawings is not intended to be limiting of the described methods, network node 210, 220, authentication node 510, 520, policy control node 350, or system, which instead are limited by the enclosed claims.

As used herein, the term “and/or” comprises any and all combinations of one or more of the associated listed items.

Further, as used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation. The common abbreviation “etc.”, which derives from the Latin expression “et cetera” meaning “and other things” or “and so on” may have been used herein to indicate that further features, similar to the ones that have just been enumerated, exist.

As used herein, the singular forms “a”, “an” and “the” are intended to comprise also the plural forms as well, unless expressly stated otherwise. It will be further understood that the terms “includes,” “comprises,” “including” and/or “comprising,” when used in this specification, specify the presence of stated features, actions, integers, steps, operations, elements, and/or components, but do not preclude the presence or addition of one or more other features, actions, integers, steps, operations, elements, components, and/or groups thereof.

It will be understood that when an element is referred to as being “on”, “coupled” or “connected” to another element, it can be directly on, coupled or connected to the other element or intervening elements may also be present. In contrast, when an element is referred to as being “directly on”, “directly coupled” or “directly connected” to another element, there are no intervening elements present.

Unless otherwise defined, all terms comprising technical and scientific terms used herein have the same meaning as commonly understood by one of ordinary skill in the art to which the described embodiments belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### DEFINITIONS

### AAA Authentication, Authorization and Accounting

### AC Access Controller

### AN Access Network

### AP Access Point

### APN Access Point Name

### ASIC Application-Specific Integrated Circuit

### BNG Broadband Network Gateway

### DHCP Dynamic Host Configuration Protocol

### EPC Evolved Packet Core

### ERF Event Reporting Function

### E-UTRAN Evolved Universal Terrestrial Radio Access Network

### GGSN Gateway GPRS Support Node

### GPRS General Packet Radio Service

### GW Gateway

### HLR Home Location Register

### HSS Home Subscriber Server

### IMSI International Mobile Subscriber Identity

### MME Mobility Management Entity

### MSISDN Mobile Station International Subscriber Directory Number

### PDN Packet Data Network

### PCRF Policy and Charging Rules Function

### PCC Policy and Charging Control

### QoS Quality-of-Service

### RAN Radio Access Network

### RAT Radio Access Technology

### RF Radio Frequency

### SGSN Serving GPRS Support Node

### SGW Serving Gateway

### SIM Subscriber Identification Module

### SoC System-on-a-Chip

### UE User Equipment

### USIM Universal SIM

WLAN Wireless LAN

1-31. (canceled)

32. A method performed by a network node in a Wi-Fi network for handling an access attempt by a wireless device, which wireless device is configured to operate in a wireless telecommunications network, and which wireless telecommunications network comprises a policy control node containing information associated with the wireless device that is registered via the wireless telecommunications network, and wherein the method comprises:
receiving the information associated with the wireless device from the policy control node, in response to transmitting an authentication request comprising an identifier associated with the wireless device to an authentication node, based on an access attempt to the Wi-Fi network by the wireless device; and
determining whether or not the access attempt by the wireless device to the Wi-Fi network is allowed at least partly based on the received information.

33. The method according to claim 32, wherein the determining is further at least partly based on radio signal information between the network node and the wireless device.

34. The method according to claim 32, wherein the identifier associated with the wireless device is an International Mobile Subscriber Identity, IMSI.

35. The method according to claim 32, wherein the identifier associated with the wireless device is a temporary identity that is mapped to an International Mobile Subscriber Identity, IMSI, in an authentication node.

36. The method according to claim 32, wherein the network node is a Wi-Fi Access Point or a Wi-Fi Access Controller.

37. An network node for handling an access attempt by a wireless device in a Wi-Fi network, which wireless device is further configured to operate in a wireless telecommunications network, which wireless telecommunications network comprises a policy control node containing information associated with the wireless device registered via the wireless telecommunications network, and wherein the network node comprises:
processing circuitry configured to receive the information associated with the wireless device from the policy control node, in response to transmitting an authentication request comprising an identifier associated with the wireless device to an authentication node, based on an access attempt to the Wi-Fi network by the wireless device, and to determine whether or not the access attempt by the wireless device to the Wi-Fi network is allowed at least partly based on the received information.

38. The network node according to claim 37, wherein the processing circuitry is further configured to determine whether or not the access attempt by the wireless device to the Wi-Fi network is allowed at least partly based on radio signal information between the network node and the wireless device.

39. The network node according to claim 37, wherein the identifier associated with the wireless device is an International Mobile Subscriber Identity, IMSI.

40. The network node according to claim 37, wherein the identifier associated with the wireless device is a temporary identity that is mapped to an International Mobile Subscriber Identity, IMSI, in an authentication node.

41. The network node according to claim 37, wherein the network node is any one of: a Wi-Fi Access Point and a Wi-Fi Access Controller.

42. A method performed by an authentication node for handling an authentication request from a network node in a Wi-Fi network, which authentication node is connected to the Wi-Fi network and a wireless telecommunications network, the method comprising:
receiving the authentication request from the network node, which authentication request comprises an identifier associated with a wireless device;
sending a request for information associated with the wireless device to a policy control node in the wireless telecommunications network, which information associated with the wireless device is registered in the policy control node via the wireless telecommunications network, and wherein the request for information associated with the wireless device is based on the identifier associated with the wireless device;
receiving the requested information associated with the wireless device from the policy control node; and
sending the received requested information associated with the wireless device to the network node in response to the authentication request.

43. The method according to claim 42, wherein the identifier associated with the wireless device is an International Mobile Subscriber Identity, IMSI.

44. The method according to claim 42, wherein the authentication node is a wireless device authentication server.

45. The method according to claim 42, wherein the authentication node is an authentication proxy node connected to a wireless device authentication server.

46. The method according to claim 45, further comprising:
sending the authentication request to the wireless device authentication server; and
receiving a response to the authentication request from the wireless device authentication server.

47. The method according to claim 46, wherein the identifier associated with the wireless device is a temporary identity, which temporary identity is mapped to an International Mobile Subscriber Identity, IMSI, or a Mobile Station International Subscriber Directory Number, MSISDN, associated with the wireless device in the wireless device authentication server.

48. The method according to claim 47, wherein the receiving further comprises receiving the IMSI or MSISDN associated with the wireless device from the wireless device authentication server, and the sending further comprises sending the IMSI or MSISDN in the request for information associated with the wireless device.

49. An authentication node for handling an authentication request from a network node in a Wi-Fi network, which authentication node is connected to the Wi-Fi network and a wireless telecommunications network, the authentication node comprising:
processing circuitry configured to receive the authentication request from the network node which authentication request comprises a identifier associated with the wireless device, and to send a request for information associated with the wireless device to a policy control node in the wireless telecommunications network, which information associated with the wireless device is registered in the policy control node via the wireless telecommunications network, and wherein the request for information associated with the wireless device is based on the identifier associated with the wireless device, and
further configured to receive the requested information associated with the wireless device from the policy control node, and to send the received requested information associated to the network node in response to the authentication request.

50. The authentication node according to claim 49, wherein the identifier associated with the wireless device is an International Mobile Subscriber Identity, IMSI.

51. The authentication node according to claim 49, wherein the authentication node is a wireless device authentication server.

52. The authentication node according to claim 49, wherein the authentication node is an authentication proxy node connected to a wireless device authentication server.

53. The authentication node according to claim 52, wherein the processing circuitry is further configured to send the authentication request to the wireless device authentication server, and receive a response to the authentication request from the wireless device authentication server.

54. The authentication node according to claim 53, wherein the processing circuitry is further configured to receive an International Mobile Subscriber Identity, IMSI, or a Mobile Station International Subscriber Directory Number, MSISDN, associated with the wireless device from the wireless device authentication server, and to send the IMSI or MSISDN in the request for information associated with the wireless device.

55. The authentication node according to claim 52, wherein the identifier associated with the wireless device is a temporary identity, which temporary identity is mapped to an International Mobile Subscriber Identity, IMSI, or a Mobile Station International Subscriber Directory Number, MSISDN, associated with the wireless device in the wireless device authentication server.

56. A method performed by a policy control node in a wireless telecommunications network for handling a request from an authentication node, which authentication node is connected to the wireless telecommunications network, and which policy control node comprises information associated with wireless devices that is registered via the wireless telecommunications network, wherein the method comprises:
receiving a request for information associated with a wireless device from the authentication node, which request for information comprises an identifier associated with the wireless device; and
sending the requested information associated with the wireless device to the authentication node.

57. The method according to claim 56, wherein the identifier is an International Mobile Subscriber Identity, IMSI, or a Mobile Station International Subscriber Directory Number, MSISDN.

58. The method according to claim 56, wherein the policy control node is a Policy and Charging Rules Function, PCRF, node.

59. A policy control node in a wireless telecommunications network for handling a request from an authentication node, which authentication node is connected to the wireless telecommunications network, and which policy control node contains information associated with wireless devices that is registered via the wireless telecommunications network, wherein the policy control node comprises:
processing circuitry configured to receive a request for information associated with a wireless device from the authentication node, which request for information comprises an identifier associated with the wireless device, and to send the requested information associated with the wireless device to the authentication node.

60. The policy control node according to claim 59, wherein the identifier is an International Mobile Subscriber Identity, IMSI, or a Mobile Station International Subscriber Directory Number, MSISDN.

61. The policy control node according to claim 59, wherein the policy control node is a Policy and Charging Rules Function, PCRF, node.

62. A system for handling an access attempt by a wireless device in a Wi-Fi network, comprising:
a network node comprised in the Wi-Fi network;
a policy control node comprised in a wireless telecommunications network, which policy control node contains information associated with wireless devices that are registered via the wireless telecommunications network; and
an authentication node connected to the Wi-Fi network and the wireless telecommunications network, in which system:
the network node is configured to transmit an authentication request comprising an identifier associated with the wireless device to an authentication node based on an access attempt to the Wi-Fi network by the wireless device;
the authentication node is configured to receive the authentication request from the network node and send a request for information associated with the wireless device to the policy control node, wherein the request for information associated with the wireless device is based on the identifier associated with the wireless device;
the policy control node is configured to receive the request for information associated with the wireless device from the authentication node, and to send the information associated with the wireless device to the authentication node;
the authentication node being further configured to receive the information associated with the wireless device from the policy control node, and send the information associated with the wireless device to the network node in response to the authentication request; and
the network node being further configured to receive the information associated with the wireless device from the policy control node in response to the transmitted authentication request, and determine whether or not the access attempt by the wireless device to the Wi-Fi network is allowed at least partly based on the received information.
